(19) United States
(12) Patent Application Publication
(10) Pub. No.: US 2012/0143375 A1
(43) Pub. Date: Jun. 7, 2012

(54) MILKING ROBOT AND METHOD FOR TEAT CUP ATTACHMENT

(75) Inventor: Marilyn Krukowski, Stockholm (SE)

(73) Assignee: DELAVAL HOLDING AB, Tumba (SE)

(21) Appl. No.: 13/389,482

(22) PCT Filed: Aug. 19, 2010
(86) PCT No.: PCT/EP2010/062080

§ 371 Date: Feb. 8, 2012

(30) Foreign Application Priority Data
Aug. 26, 2009 (SE) 0950614-8

(51) Int. Cl. G05B 19/00

(52) U.S. Cl. 700/259; 901/47

(57) ABSTRACT

A milking robot for teat cup attachment includes a robot arm having a gripper for holding at least one teat cup at a time; an image recording device mounted on the robot arm and provided to record at least one image of the teats of a milking animal; and a control device provided to control the robot arm to position the teat cup at a teat of the milking animal based on the at least one image of her teats. The image recording device is, before being provided to record the at least one image of the teats of the milking animal, provided to record at least one image of her hind legs; and the control device is, before being provided to control the robot arm to attach the teat cup to the teat of the milking animal, provided to control the robot arm to move the teat cup between her hind legs, from her rear and towards her udder, based on the at least one image of her hind legs. The milking robot further including a pivoting device for pivoting the image recording device with respect to the gripper of the robot arm between the recording of the at least one image of the hind legs of the milking animal and the recording of the at least one image of her teats.

### TECHNICAL FIELD OF THE INVENTION

The present invention generally relates to dairy farm robot milking and to automatic attachment of teat cups related thereto.

### DESCRIPTION OF RELATED ART AND BACKGROUND OF THE INVENTION

There is known a method of automatically milking animals which are arranged behind each other in milk boxes that are adjacent to each other in a longitudinal direction. In the method a robot arm construction is movable in longitudinal direction along the milk boxes, by which carriers with teat cups can be seized and be brought to under the udder of animals in the milk boxes, where after the teat cups can be connected one by one to the teats of the animals.

WO 98/35547 discloses such a robot arm construction comprising a slidable support structure and a sidewardly pivotable portion which includes an essentially downwardly extending carrier and seizing means fastened thereto, which are pivotable about a substantially horizontal pivotal axis which is located at or near the upper side of the milking parlor in the longitudinal direction thereof. The seizing means comprise a portion, extending obliquely downwards in the direction of the compartments, and a horizontal seizing element. For the purpose of controlling the seizing means a detector is fastened thereto, by means of which detector the position of the teats can be determined. When an animal, preferably a goat, is present in the milking parlor and the teat cups have to be connected, the robot arm construction first has to be moved in the longitudinal direction of the milking parlor, i.e. in a position in which the seizing means are pivoted to under the animal into a position in which it is possible for the detector to determine the position of the teats. After having been seized, a teat cup can be connected to a teat by moving the sidewardly pivotable portion to under the udder of the goat between the hind legs while the detector is able to observe the teats between the hind legs.

EP 0313109 discloses an implement for milking animals, such as cows, comprising at least one milking parlor and at least one milking machine with a milking cluster wherein means are provided for automatically applying the milking cluster from the rear of the animal and coupling the milking cluster to the udder of the animal. A sensor is provided in the floor so as to make it possible to observe whether the hind legs of the animal are at the desired place. The sensor can detect whether the two hind legs are in the appropriate place, whereafter the milking cluster can be connected. The means includes an arm at whose end a sensor or indicator is provided such that the means can be controlled to a desired position relative to the animal present in the milking parlor, with the object of connecting the teat cups to the teats of the animal.

### SUMMARY OF THE INVENTION

A problem with the approach disclosed in WO 98/35547 is that the use of a single detector in the manner disclosed requires an exact positioning of the animal, or incorrect teat cup positionings may occur. An exact positioning of the animal may not always be possible, in particular when milking cows in rotary milking systems. Further, the pivoting of the seizing means requires space for the support structure and may not always be practical to use.

A problem with the approach disclosed in EP 0313109 is that two sensors have to be used, one sensor for detecting the hind legs of the animal and one sensor or indicator for use during connection of the teat cups to the teats of the animal. Such solution is obviously complex and thus costly.

Accordingly, it is an object of the present invention to provide a milking robot and a method for teat cup attachment, by which at least some of the problems of the prior art as set forward above is alleviated or mitigated.

It is a further object of the invention to provide such a milking robot and such a method, which are robust, effective, fast, precise, accurate, reliable, safe, easy to use, and of low cost.

It is still a further object of the invention to provide such a milking robot and such a method, which are capable of obtaining a very high number of correct teat cup attachments.

These objects among others are, according to the present invention, attained by milking robots and methods as claimed in the appended patent claims.

According to one aspect of the invention, a milking robot for teat cup attachment is provided, the robot comprising a robot arm having a gripper for holding at least one teat cup at a time, an image recording device mounted on the robot arm, and a control device. In a first stage of operation, the image recording device is provided to record at least one image of the hind legs of a milking animal and the control device is provided to control the robot arm to move the teat cup between the hind legs of the milking animal, from the rear of the milking animal and towards the udder, based on the at least one image of the hind legs of the milking animal. In a second following stage of operation, the image recording device is provided to record at least one image of the teats of the milking animal and the control device is provided to control the robot arm to position the teat cup at a teat of the milking animal based on the at least one image of the teats of the milking animal. The milking robot comprises means for pivoting or rotating the image recording device with respect to the gripper of the robot arm between the two operation stages.

By such arrangement a good recording of the hind legs of the milking animal can be made having the image recording device suitably oriented. By aid of the position of the hind legs of the animal the robot arm can move the teat cup between the hind legs of the milking animal from behind and towards the udder. After this, the image recording device is tilted to reach a suitable orientation for recording a good image of the teats of the milking animal in order to allow for a fast and reliable teat cup attachment.

Preferably, the image recording device is directed essentially horizontally or slightly diagonally upwards before the pivoting and diagonally upwards after the pivoting. For instance, the optical axis of the image recording device may form an angle with respect to the horizontal plane which is between about −15 and +15 degrees before pivoting and between about +5 and +90 degrees after pivoting. The pivot axis is positioned suitably with respect to the image recording device, e.g. behind, below, or to go through the image recording device.

In one embodiment of the invention the gripper is located at the far end of the robot arm and the image recording device is mounted on the robot arm at a distance behind the gripper. Here, the pivoting is performed around a horizontal axis being essentially perpendicular to a main movement direction of the robot arm.

In another embodiment the image recording device is mounted at the far end of the robot arm and the gripper is located at a distance behind the image recording device. Here, the pivoting is performed around the above identified horizontal axis or around a vertical axis.

In yet another embodiment the pivoting means is comprised of at least two joints of the robot arm around which vertical pivoting can be made. The image recording device is rigidly attached to one of the robot arm parts and will be pivoted vertically with respect to the gripper when pivoting the robot arm parts at the joints.

According to a second aspect of the invention a method for teat cup attachment is provided. According to the method at least one teat cup at a time is gripped by a gripper of a robot arm, at least one image of the hind legs of a milking animal is recorded by the image recording device, the robot arm is controlled to move the teat cup from the rear, between the hind legs, and towards the udder of the milking animal based on the at least one image of the hind legs of the milking animal, the image recording device is thereafter pivoted with respect to the gripper of the robot arm, at least one image of the teats of the milking animal is recorded by the image recording device mounted on the robot arm, and the robot arm is controlled to position the teat cup at a teat of the milking animal based on the at least one image of the teats of the milking animal.

Further characteristics of the invention, and advantages thereof, will be evident from the following detailed description of preferred embodiments of the present invention given hereinafter and the accompanying FIGS. 1-4, which are given by way of illustration only, and are thus not limitative of the present invention.

### BRIEF DESCRIPTION OF THE DRAWINGS

FIGS. 1a-b display schematically, in side views, a milking robot in two different operation stages according to an embodiment of the present invention.

FIGS. 2a-b display schematically, in side views, a milking robot in two different operation stages according to a further embodiment of the invention.

FIGS. 3a-b display schematically, in side views, a robot arm of a milking robot in two different operation stages according to a yet further embodiment of the invention.

FIGS. 4a-b display schematically, in top views, a robot arm of a milking robot in two different operation stages according to a still further embodiment of the invention.

### DETAILED DESCRIPTION OF EMBODIMENTS

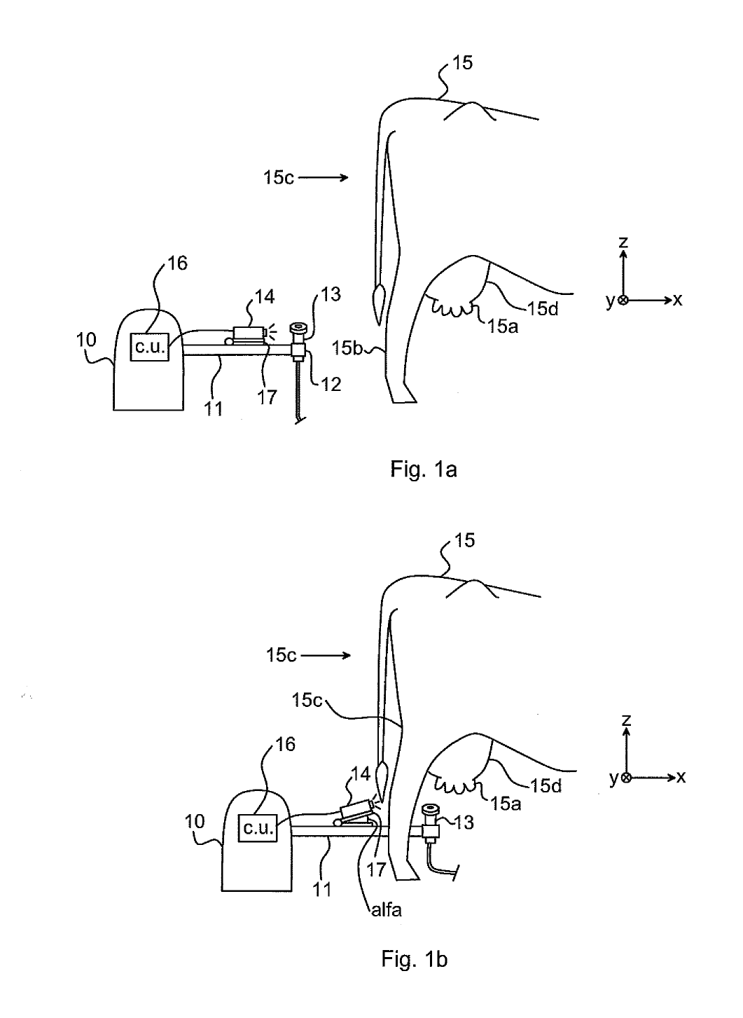

In FIGS. 1a-b are shown a milking robot 10 in two different operation stages according to an embodiment of the present invention. The milking robot comprises a robot arm 11, a gripper 12 mounted at the far end of the robot arm 11 for gripping at least one teat cup 13 at a time, an image recording device 14 attached to the robot arm 11, a pivoting device 17 for pivoting or rotating the image recording device 14 with respect to the gripper 12 of the robot arm 11 around a horizontal axis y being essentially perpendicular to a main movement direction x of the robot arm, and a control device 16 for control of the milking robot 10 and its parts. The gripper 12 is conveniently located at the far end of the robot arm 11 and the image recording device 14 is attached to the robot arm 11 at a distance behind the gripper 12.

The teat cup 13 is a teat cup of a milking system which may be any kind of milking system in the art such as e.g. a rotary or other milking system with parallel stall configuration wherein the udders of the milking animals can be accessed from behind. The milking robot of the present invention may also be used in different kind of voluntary or fully automated milking systems.

The image recording device 14 may be any kind of image recording device in the art such as e.g. a time-of-flight camera.

The pivoting device 17 may be realized in a plurality of manners readily available to a skilled person and it may be powered hydraulically, pneumatically, or by an electric motor (not illustrated) depending e.g. on how the milking robot 10 is powered. The horizontal axis around which the pivoting is performed is located suitably with respect to the imnage recording device, e.g. behind and/or below the image recording device 14. Alternatively, the pivot axis goes through the image recording device 14.

The milking robot 10 operates in the following manner. In a first operation stage, a milking animal location stage, the image recording device 14 is provided to record at least one image of the hind legs 15b of a milking animal 15 and the control device 16 is provided to control the milking robot 10 to move the teat cup 13 from the rear 15c of the milking animal 15 and towards the udder 15d of the milking animal 15 between the hind legs 15b based on the at least one image of the hind legs 15b. This stage of operation is illustrated in FIG. 1a.

The image recording device 14 is during the first operation stage directed essentially forward in the x direction wherein the optical axis of the image recording device 14 forms an angle α with the horizontal plane xy of between about −15 and +15 degrees. Preferably, the image recording device 14 is directed horizontally or slightly diagonally upwards. Hereby, the image recording device 14 can easily view the rear 15c and the hind legs 15b of the milking animal 15.

While the milking animal is illustrated as a cow in FIG. 1a, it shall be appreciated that the present invention is applicable to any kind of milking animal such as e.g. cow, goat, sheep, or buffalo.

When the first stage of operation is terminated, the control device 16 controls the pivoting device 15 to pivot the image recording device 14 with respect to the gripper 12 of the robot arm 11 such that the image recording device 14 is advantageously directed diagonally upwards after the pivoting. Preferably, the optical axis of the image recording device 14 makes an angle α with the horizontal plane xy of between about +5 and +90 degrees after pivoting.

In a second or following stage of operation, the image recording device 14 is provided to record at least one image of the teats 15a of the milking animal 15 and the control device 16 is provided to control the robot arm 11 to position the teat cup 13 at a teat 15a, preferably a front teat, of the milking animal 15 based on the at least one image of the teats of the milking animal 15. The second stage of operation is illustrated in FIG. 1b. The direction of the image recording device 14 allows the image recording device 14 to easily view all teats 15a of the milking animal 15.

It shall be appreciated that the image recording device 14 may be continuously recording images during the two stages of operation to support the control device 16 with position data to facilitate the control of the robot arm 11.

It shall further be appreciated that the control device 16 may control the pivoting device 15 to pivot the image recording device 14 with respect to the gripper 12 of the robot arm 11 continuously or repeatedly during the two stages of operation, e.g., the angle α is controlled in response to the distance between the teat cup 13 and the teat 15a of the milking animal 15 at which the teat cup 13 is to be positioned.

Advantageously, the angle α is controlled to increase monotonously with decreasing distance between the teat cup 13 and the teat 15a of the milking animal 15 at which the teat cup 13 is to be positioned.

In milking systems wherein only one teat cup at a time is positioned at a respective teat of the milking animal the following alternatives are possible.

The angle α is held at a first value during the second operation stage of attachment of a teat cup to a back teat of the milking animal and at a second value during the second operation stage of attachment of a teat cup to a back teat of the milking animal, wherein the first value is preferably lower than the second value.

Still alternatively, the tilting of the image recording device is only made for attachment of teat cups to the front teats of the milking animal.

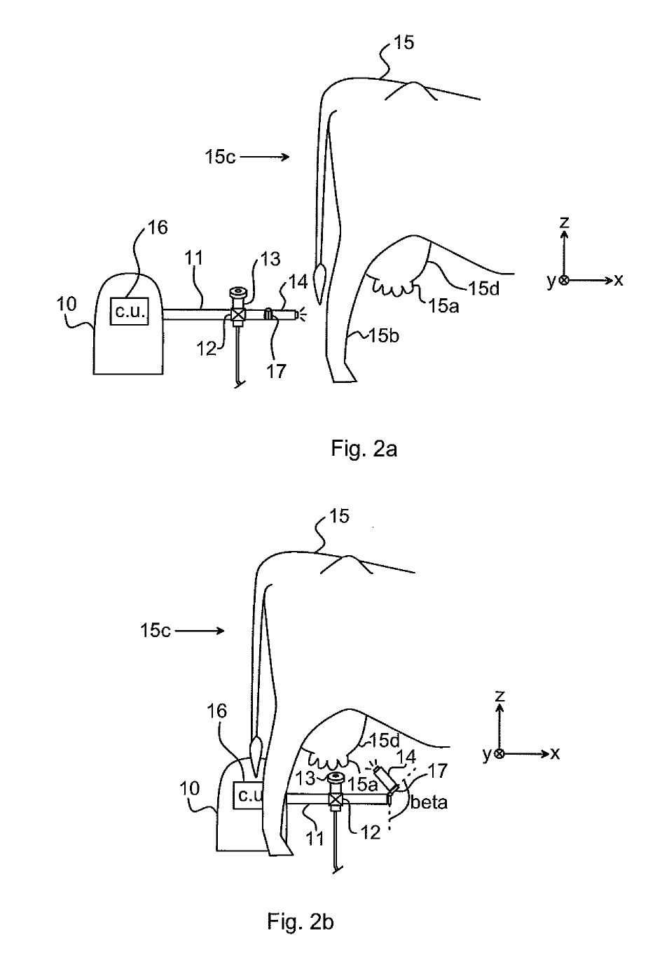

In FIGS. 2a-b are shown a milking robot 10 in the two different operation stages according to a further embodiment of the invention. This embodiment differs from the FIGS. 1a-b embodiment in that the image recording device 14 is mounted at the far end of the robot arm 11 and the gripper 12 is located at a distance behind the image recording device.

The pivoting is made an angle β which is between about 90 and 175 degrees with respect to the horizontal plane xy and the arm is moved a further distance under the milking animal 15 such that the teat cup 13 held by the gripper 12 can be positioned at the teats 15a of the milking animal 15.

In this embodiment particularly, the control device 16 is provided to control the pivoting device 15 to pivot the image recording device 14 with respect to the gripper 12 of the robot arm 11 continuously during the two stages of operation.

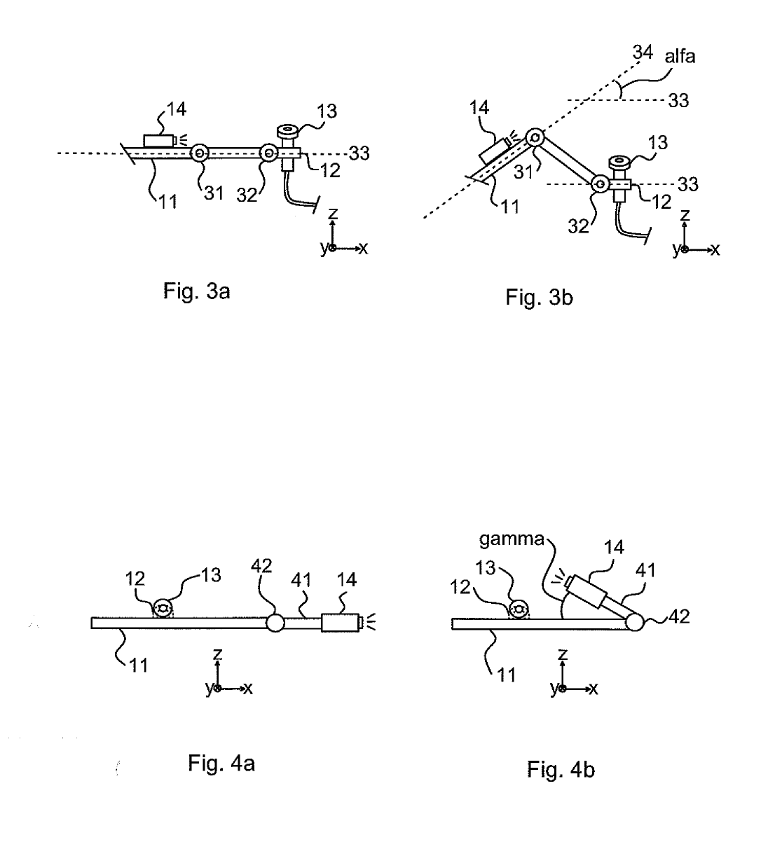

In FIGS. 3a-b are shown a robot arm 11 of a milking robot in the two different operation stages according to a yet further embodiment of the invention. This embodiment differs from the FIGS. 1a-b embodiment in that the pivoting device 17 is exchanged for two joints 31 and 32, the first one 31 dividing the robot arm 11 in two parts where the image recording device is rigidly mounted on the rearmost one and the other one 32 of the joints separating the gripper 12 from the robot arm 11. By means of the joints 31, 32 the two parts of the robot arm 11 and the gripper 12 can be pivoted with respect to one another around horizontal axes. The pivoting as described with reference to FIGS. 1a-b is emulated by pivoting the front part of the robot arm 11 clockwise with respect to the rearmost part of the robot arm 11 and pivoting the gripper counter clockwise with respect to the front part of the robot arm 11 as being illustrated in FIGS. 3a-b.

In FIGS. 3a-b the horizontal axis is indicated by 33 and the extension line of the rearmost part of the robot arm 11 being parallel with the optical axis of the image recording device 14 is indicated by 34 to allow the angle α to be clearly indicated. It shall be appreciated that due to the pivoting of the robot arm 11 at the two joints 31, 32 the effective length of the robot arm 11 will be shorter, a reality that has to be compensated for during the movement of the robot arm 11.

In FIGS. 4a-b are shown a robot arm 11 of a milking robot in the two different operation stages according to a still further embodiment of the invention. This embodiment differs from the FIGS. 2a-b embodiment in that the pivoting device 17 is exchanged for an image recording device support 41 connected to the robot arm 11 via a joint 41 allowing the image recording device support 41 and the image recording device attached to the image recording device support 41 to be pivoted with respect to the robot arm 11 and the gripper 12 around a vertical axis z. In FIG. 4b the pivoting has been made almost 180 degrees leaving an angle γ between the robot arm 11 and the image recording device 14.

It shall be appreciated that the various embodiments of the present invention may be combined in order to reach yet further embodiments of the invention. In particular, it shall be noted that the embodiments of FIGS. 2 and 4 may be combined such that two pivoting devices are provided for pivoting the image recording device 14 around both a horizontal axis and a vertical axis.

1-11. (canceled)

12. A milking robot (10) for teat cup attachment to teats of a milking animal by accessing an udder of the milking animal from behind the milking animal, the milking robot comprising:
a robot arm (11) having a main movement direction (x);
a gripper (12) mounted at a first point along a length of the robot arm, the gripper (12) for holding a teat cup (13);
an image recording device (14) configured to record images of the teats (15a) of the milking animal (15), the image device mounted at a second point along the length of the robot arm;
a pivoting device (17, 31, 33, 41, 42) configured for pivoting the image recording device with respect to the gripper; and
a control device (16) operatively connected to the robot arm, the image recording device, and the pivoting device,
said control device configured to having the gripper grip and hold the teat cup;
said control device configured, i) with said image recording device and said gripper at a first location at a rear (15c) of the milking animal and located between hind legs of the milking animal, and ii) with the image recording device in a first position with respect to the gripper, to have the image recording device record an image of hind legs (15b) of the milking animal from the first location,
said control device configured i) to move the robot arm, based on the image of the hind legs, from the first location a second location towards the udder (15d) of the milking animal, and ii) to have the pivoting device pivot the image recording device from the first position to a second position with respect to the gripper, to have the image recording device record an image of the teats of the milking animal,
said control device configured to control the gripper to position the teat cup at one teat of the milking animal based on the the image of the teats taken by the image recording device at the second location with the image recording device at the second position; and
said control device configured to attach the teat cup to the one teat once the gripper has positioned the teat cup at the one teat.

13. The milking robot of claim 12, wherein,
said pivoting device is configured for pivoting the image recording device with respect to the gripper around a horizontal axis (y) in a vertical direction (z) perpendicular to the main movement direction (x) of the robot arm, and
the first and second points are respectively one of:
i) an intermediate point along the length of the robot arm, and ii) a far end point of the robot arm, and
i) the far end point of the robot arm, and ii) the intermediate point along the length of the robot arm.

14. The milking robot of claim 13, wherein,
in the first position, an optical axis of the image recording device forms a first angle with a horizontal plane (xy) of between about −15 and +15 degrees, with the optical axis directed towards the rear and the hind legs of the milking animal, and
in the second position, the optical axis is directed diagonally upwards and makes a second angle with the horizontal plane (xy) of between i) about +5 degrees and +90 degrees, and ii) about +90 degrees and 175 degrees, with the optical axis directed towards the teats of the animal, the second angle being greater than the first angle.

15. The milking robot of claim 12, wherein,
said control device is configured to have the pivoting device pivot the image recording device with respect to the gripper in response to a distance between the teat cup and the one teat of the milking animal at which the teat cup is to be positioned.

16. The milking robot of claim 12, wherein,
said control device is configured to have the pivoting device pivot the image recording device with respect to the gripper such that the second angle is controlled to increase monotonously with decreasing distance between the teat cup and the one teat of the milking animal at which the teat cup is to be positioned.

17. The milking robot of claim 12, wherein,
said one teat to which the control device is configured to control the gripper to position the teat cup at, based on the the image of the teats taken by the image recording device at the second location with the image recording device at the second position, is a front teat of the animal.

18. The milking robot of claim 13, wherein,
said pivoting device pivotably mounts the image recording device to the robot arm,
the first and second points are respectively i) the far end point of the robot arm, and ii) the intermediate point along the length of the robot arm, the intermediate point at a distance behind the gripper.

19. The milking robot of claim 13, wherein,
said pivoting device pivotably mounts the image recording device to the robot arm,
the first and second points are respectively i) the intermediate point along the length of the robot arm, and ii) the far end point of the robot arm, the intermediate point at a distance behind the image recording device.

20. The milking robot of claim 13, wherein,
said pivoting device comprises a first joint (31) and a second joint (32),
the first joint (31) divides the robot arm in a rearmost part and a foremost part,
the image recording device is mounted on the rearmost part,
the second joint (32) pivots the gripper (12) on the formemost part,
the first and second joints (31, 32) pivots the the rearmost and foremost parts of the robot arm, and the gripper and image recording device, with respect to one another around the horizontal axis, and
the first and second points are respectively i) the far end point of the robot arm, and ii) the intermediate point along the length of the robot arm, the intermediate point at a distance behind the gripper.

21. The milking robot of claim 13, wherein,
said pivoting device pivotably mounts the image recording device to the robot arm, the pivoting device comprising a image recording device support (41) connecting the image recording device to the robot arm via a robot arm joint (42), the image recording device being further pivotable about a vertical axis (z) via the robot arm joint (42), and
the first and second points are respectively i) the intermediate point along the length of the robot arm, and ii) the far end point of the robot arm, the intermediate point at a distance behind the image recording device.

22. The milking robot of claim 12, wherein,
the pivoting device is configured to pivot the image recording device around a vertical axis (z) and the image recording device is mounted at the far end of the robot arm and the gripper is located at a distance behind the image recording device.

23. A milking system comprising the milking robot of claim 12.

24. The milking system of claim 23, wherein,
the milking system is a rotary milking system with a parallel stall configuration.

25. The milking robot of claim 12, wherein,
the pivoting device is configured to pivot the image recording device around a horizontal axis (y) in a direction (z) perpendicular to a main movement direction (x) of the robot arm.

26. The milking robot of claim 25, wherein,
in the first position, the image recording device is at a first angle within a range directed horizontally (xy) up to 15 degrees above the horizontal plane (xy), and
in the second position, the image recording device is at a second angle greater than the first angle.

27. The milking robot of claim 25, wherein,
in the first position, the image recording device is at a first angle with respect to the horizontal plane (xy) between about −15 and +15 degrees, and
in the second position, the image recording device is at a second angle greater than the first angle, and with respect to the horizontal plane (xy) is between +5 and +90 degrees.

28. The milking robot of claim 12, wherein,
the gripper is located at a far end of the robot arm and the image recording device is mounted on the robot arm at a distance behind the gripper.

29. The milking robot of claims 12, wherein,
the image recording device is mounted at a far end of the robot arm and the gripper is located at a distance behind the image recording device.

30. A method for teat cup attachment, comprising the steps of:
a) using a milking robot (10) for teat cup attachment to teats of a milking animal by accessing an udder of the milking animal from behind the milking animal, the milking robot comprising:
a robot arm (11) having a main movement direction (x);
a gripper (12) mounted at a first point along a length of the robot arm, the gripper (12) for holding a teat cup (13);
an image recording device (14) configured to record images of the teats (15a) of the milking animal (15), the image device mounted at a second point along the length of the robot arm;
a pivoting device (17, 31, 33, 41, 42) configured for pivoting the image recording device with respect to the gripper; and
a control device (16) operatively connected to the robot arm, the image recording device, and the pivoting device,
b) gripping at least one teat cup at a time by a gripper (12) of a robot arm (11);
c) with said image recording device and said gripper at a first location at a rear (15c) of the milking animal and located between hind legs of the milking animal, and with the image recording device in a first position with respect to the gripper, having the image recording device record an image of hind legs (15b) of the milking animal from the first location;
d) moving the robot arm, based on the image of the hind legs, from the first location a second location towards the udder (15d) of the milking animal, and having the pivoting device pivot the image recording device from the first position to a second position with respect to the gripper, to have the image recording device record an image of the teats of the milking animal;
e) controlling the gripper to position the teat cup at one teat of the milking animal based on the the image of the teats taken by the image recording device at the second location with the image recording device at the second position; and
f) attaching the teat cup to the one teat once the gripper has positioned the teat cup at toe one teat.
